(19) United States
(12) Patent Application Publication
(10) Pub. No.: US 2026/0030937 A1
(43) Pub. Date: Jan. 29, 2026

(54) COOLANT MONITORING SYSTEM

(71) Applicant: FCA US LLC, Auburn Hills, MI (US)

(72) Inventors: Mahlon C. Smith, Auburn Hills, MI (US); Mark A. Kamm, Auburn Hills, MI (US); Alan G. Falkowski, Auburn Hills, MI (US)

(21) Appl. No.: 18/782,543

(22) Filed: Jul. 24, 2024

(51) Int. Cl. G07C 5/08; G01M 3/00; G01M 3/26; H01M 10/613; H01M 10/625; H01M 10/63; H01M 10/6568

(52) U.S. Cl. CPC G07C 5/0808; G01M 3/26; G07C 5/0816; H01M 10/613; H01M 10/625; H01M 10/63; H01M 10/6568; H01M 2220/20

(57) ABSTRACT

A coolant monitoring system for a vehicle cooling system, an engine cooling system and/or a battery cooling system. A cooling pressure sensor is coupled with the vehicle, engine and/or battery cooling systems. A temperature sensor is coupled with the vehicle, engine and/or battery cooling systems. A time measurement device is present. A controller is coupled with the cooling pressure sensor, temperature sensor and time measurement device. The controller monitors pressure and temperature valves with respect to time at various operating conditions and compares the pressure and temperature values with known acceptable pressure and temperature valves when no leaks are present to determine if a coolant leak exists.

### FIELD

The present disclosure relates to vehicles and, more particularly, to a system for monitoring a vehicle cooling system.

### BACKGROUND

This section provides background information related to the present disclosure which is not necessarily prior art.

In a vehicle, the cooling system includes several components such as cooling pipes, cooling plates, cooling manifold, radiator and battery or engine cooling components. Thus, in the vehicle cooling systems, leaks can go undetected without monitoring pressure and temperature. Thus, it would be desirable to monitor cooling system pressure under different operating conditions and compare the values to acceptable values. Thus, lack of solutions allowing cooling systems leaks to go undetected may result in vehicle issues.

Accordingly, it an object of the disclosure to provide a system that identifies potential coolant leaks in either the vehicle cooling system, engine cooling system or battery cooling system. The cooling system would alert a vehicle driver of any possible coolant leaks. The disclosure provides cooling pressure and temperature information as time measurements to evaluate the coolant pressure under different operating conditions and compares them with acceptable pressure value and rate of pressure change when there is no leaks in the system to determine if a coolant leak may exist. If a result is a pressure deviation or rate change from expected values, there is an alert sent to the vehicle human machine interface to alert the driver of the condition.

### SUMMARY

This section provides a general summary of the disclosure, and is not a comprehensive disclosure of its full scope or all of its features.

According to a first aspect of the disclosure, a coolant monitoring system comprises a vehicle cooling system, an engine cooling system, time measurement device and a battery cooling system. A cooling pressure sensor and temperature sensor are coupled with the vehicle, engine or battery cooling systems. A controller is coupled with the cooling pressure sensor, temperature system sensor and time management device. The controller monitors the pressure and temperature values with respect to time at various operating conditions. The controller compares the pressure and temperature values with known accepted pressure and temperature values when no leaks are present to determine if a coolant leak exists. The system sends an alert if a pressure deviation or rate change exists between expected values. The operating conditions include coolant pumps, start up, coolant pump during running conditions and after the coolant pump shuts down. The driver would be notified of the condition.

According to a second aspect of the disclosure, a vehicle comprises a vehicle coolant system, an engine cooling system and a battery cooling system and a time measurement device. A cooling pressure sensor and temperature sensor are coupled with the vehicle, engine or battery cooling systems. A controller is coupled with the cooling pressure sensor, temperature system sensor and time management device. The controller monitors the pressure and temperature values with respect to time at various operating conditions. The controller compares the pressure and temperature values with known accepted pressure and temperature values when no leaks are present to determine if a coolant leak exists. The system sends an alert if a pressure deviation or rate change exists between expected values. The operating conditions include coolant pump start up, coolant pump during running conditions and after the coolant pump shuts down. The driver would be notified of the condition.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a coolant monitoring system.

FIG. 2 is a graph of coolant pressure to time.

FIG. 3 is a graph of coolant pressure to time with a leak.

FIG. 4 is a graph of coolant pressure to time to time.

FIG. 5 is a graph of coolant pressure to time to time with a leak.

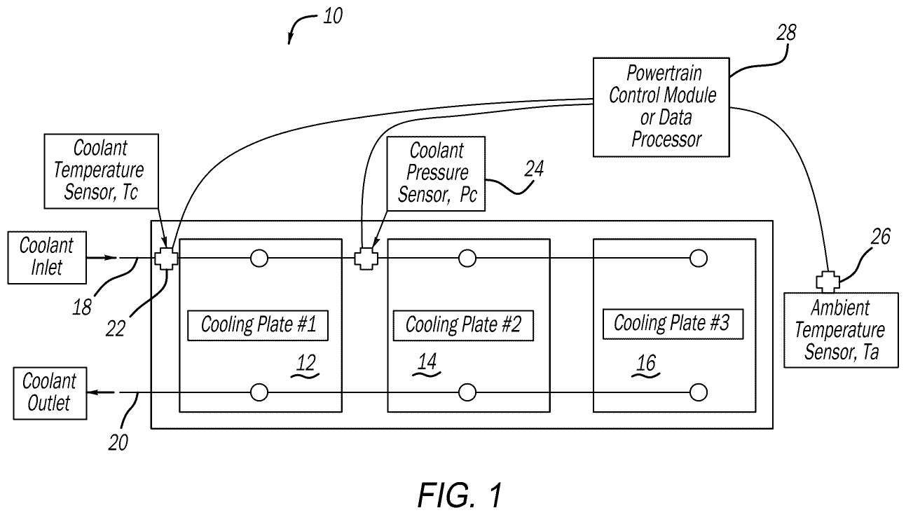

Corresponding reference numerals indicate corresponding parts throughout the several views of the drawings.

### DETAILED DESCRIPTION

Example embodiments will now be described more fully with reference to the accompanying drawings.

Turning to the figures, a coolant monitoring system is illustrated and designated with the reference numeral 10. A cooling battery pack 11 is shown; however, the system 10 relates to a coolant monitoring system for vehicle cooling systems, engine cooling systems or the like. The system includes cooling plates 12, 14, 16 of the battery pack. A coolant inlet line 18 deliver coolant to the cooling plates 12, 14, 16. Also, a coolant outlet line 20 returns the coolant back to the sump (not shown). The coolant is cooled and then recirculated through the battery pack.

A coolant temperature sensor 22 is positioned on the coolant inlet line 18. Also, a coolant pressure sensor 24 is positioned on the coolant inlet line 18. Further, an ambient temperature sensor 26 is positioned outside the vehicle. The coolant temperature sensor 22, coolant pressure sensor 24 and the ambient temperature sensor 26 are electrically coupled with the powertrain control module or a data processor (controller) 28. The controller 28 receives the data information from the coolant temperature sensor 22, coolant pressure sensor 24 and ambient temperature sensor 26.

The coolant temperature sensor 22, coolant pressure sensor 24 along with a time measurement are used to evaluate the coolant pressure under different operating conditions. These operating conditions may be monitored at the cooling pump start up, cooling pump running at different speeds and cooling pump shut down.

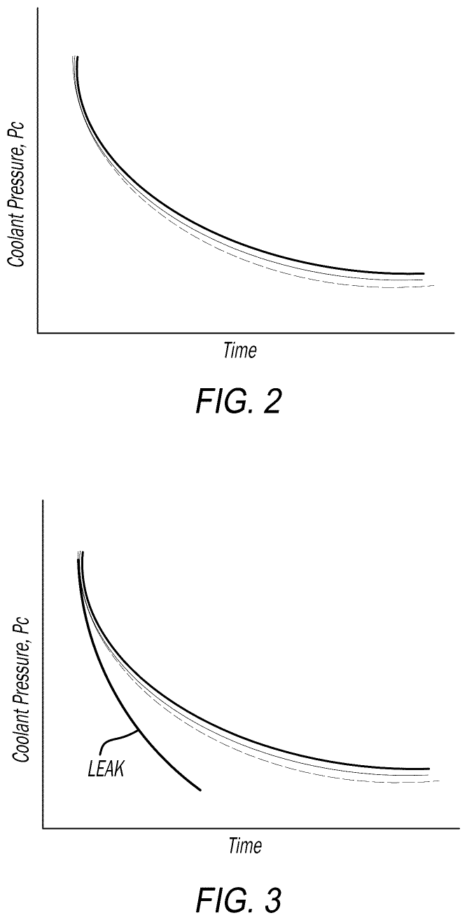

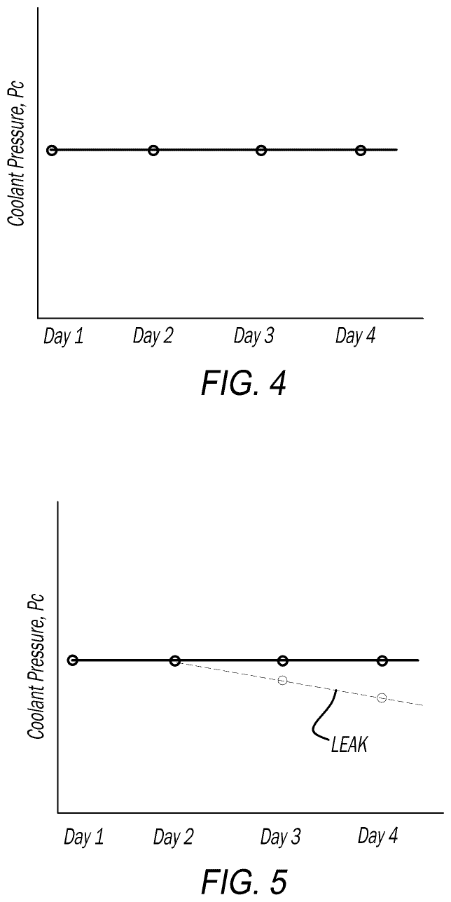

The controller 28 compares the values with acceptable pressure values and rates of pressure changes when there are no leaks in the system to determine if a coolant leak may exist as illustrated in FIGS. 2 and 4. If the result is a pressure deviation or a rate change from expected values, an alert is sent to the vehicle human machine interface to alert the driver to the condition. Thus, if a leak occurs as illustrated in graphs 3 and 5, a signal would be sent to the human machine interface.

Accordingly, as illustrated in FIGS. 2 and 4, the normal curves indicate that the system volumes are normal. If a leak occurs in FIGS. 3 and 5, the coolant pressure lowers and the system has a leak indicated by pressure dropping quicker than a system with no leaks.

Additionally, the coolant pressure is recorded at the same coolant temperature and pump speed over time with no drop in pressure. This indicates that the system is normal as illustrated in graph 4. If a leak occurs in FIGS. 3 and 5, such as a slow leak, pressure falls off each time it is monitored indicating that a leak has occurred. At a given ambient temperature, there is a relationship between pressure and temperature in a closed system. When a leak occurs, pressure will drop at a quicker than normal rate when the water pump is not running. When this pressure drops quicker than normal over time, it is an indication that a leak is present. The consumer can be notified that service action is required.

When the system is in operation, the coolant pressure Pc can be monitored at a given time Tc over time. The coolant pressure should be constant at that time. If it is not, then a leak is present and the consumer can be notify.

Thus, a coolant monitoring system 10 to detect possible leaks can be provided utilizing existing technology in cooling pressure and temperature sensors and time measurements to evaluate the coolant pressure under different operating conditions. It compares it with acceptable pressure values and rates of pressure changes when there are no leaks in the system to determine if a coolant leak may exist. If a leak exists, due to the pressure deviation or rate change from expected values, an alert is sent to the vehicle human machine interface to alert the driver of the condition.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A coolant monitoring system comprising:
a vehicle cooling system, an engine cooling system and/or a battery cooling system;
a cooling pressure sensor coupled with the vehicle, engine and/or battery cooling systems;
a temperature sensor coupled with the vehicle, engine and/or battery cooling systems;
a time measurement device;
a controller coupled with the cooling pressure sensor, temperature sensor and time measurement device, the controller monitoring pressure and temperature valve with respect to time at various operating conditions and comparing the pressure and temperature values with known acceptable pressure and temperature valves when no leaks are present to determine if a coolant leak exists.

2. The coolant monitoring system of claim 1, wherein sending an alert if a pressure deviation or rate change from expected values is sensed.

3. The coolant monitoring system of claim 1, wherein monitoring at cooling pump start up, cooling pump during running conditions and after cooling pump shut down.

4. The coolant monitoring system of claim 1, wherein notifying the driver to the condition.

5. The coolant monitoring system of claim 1, including an ambient temperature sensor.

6. A vehicle comprising:
a vehicle coolant system, an engine cooling system and a battery cooling system and a coolant monitoring system comprising:
a cooling pressure sensor coupled with the vehicle, engine and/or battery cooling systems;
a temperature sensor coupled with the vehicle, engine and/or battery cooling systems;
a time measurement device;
a controller coupled with the cooling pressure sensor, temperature sensor and time measurement device, the controller monitoring pressure and temperature valve with respect to time at various operating conditions and comparing the pressure and temperature values with known acceptable pressure and temperature valves when no leaks are present to determine if a coolant leak exists.

7. The vehicle of claim 6, wherein sending an alert if a pressure deviation or rate change from expected values is sensed.

8. The vehicle of claim 6, wherein monitoring at cooling pump start up, cooling pump during running conditions and after cooling pump shut down.

9. The vehicle of claim 6, wherein notifying the driver to the condition.

10. The vehicle of claim 6, including an ambient temperature sensor.
